(19) United States
(12) Patent Application Publication
(10) Pub. No.: US 2015/0080501 A1
(43) Pub. Date: Mar. 19, 2015

(54) Combination of a Stable Nitroxyl Radical and a Quinone Methide as Stabiliser for Reaction Resin Mortars Based on Radically Curable Compounds

(71) Applicant: Hilti Aktiengesellschaft, Schaan (LI)

(72) Inventors: Anna Khalyavina, Augsburg (DE); Armin Pfeil, Kaufering (DE); Beate Gnass, Gersthofen (DE); Michael Leitner, Landsberg (DE)

(21) Appl. No.: 14/395,376

(22) PCT Filed: Apr. 10, 2013
(86) PCT No.: PCT/EP2013/057439

§ 371 Date: Oct. 17, 2014

(30) Foreign Application Priority Data
Apr. 20, 2012 (DE) 10 2012 206 579.2

(51) Int. Cl. C04B 28/28; C04B 14/06; C04B 16/00

(52) U.S. Cl. CPC C04B 28/28; C04B 16/00; C04B 14/06
USPC 524/5; 206/223

(57) ABSTRACT

The use of a combination of at least one stable nitroxyl radical and at least one quinone methide as a stabilizer for resin mixtures and reactive resin mortars, each based on radically curable compounds, is described. Resin mixtures and in particular reactive resin mortars may be combined very effectively with a combination of at least one stable nitroxyl radical and at least one quinone methide to make them stable in storage.

This application claims the priority of International Application No. PCT/EP2013/057439, filed Apr. 10, 2013, and German Patent Document No. 10 2012 206 579.2, filed Apr. 20, 2012, the disclosures of which are expressly incorporated by reference herein.

### DESCRIPTION

The present invention relates to the use of a combination of at least one stable nitroxyl radical and at least one quinone methide as a stabilizer for resin mixtures and reactive resin mortars, each based on radically curable compounds. Furthermore, the present invention relates to a reactive resin mixture that is stable in storage as well as a reactive resin mortar that is stable in storage, each based on radically curable compounds as well as their use as binders for the chemical bonding technology.

It has long been known that reactive resin mortars based on radically curable compounds may be used as binders. In the field of fastening technology, the use of resin mixtures as organic binders for chemical fastening technology, for example, as dowel compositions has been successful. These are composite compositions, which are manufactured as multicomponent systems, wherein one component, i.e., the A component, contains the resin mixture and the other component, the B component, contains the curing agent. Other conventional ingredients such as organic or inorganic additives, for example, fillers, accelerators, stabilizers, inhibitors, thixotropy agents, stabilizing agents, thickeners and solvents, including reactive solvents (reactive diluents) and dyes may be present in one and/or the other component. Then, by mixing the two components, the curing reaction, i.e., polymerization, is initiated by formation of free radicals and the resin is cured to form the thermosetting plastic.

Vinyl ester resins and unsaturated polyester resins are frequently used as the radically curable compounds, in particular for the chemical fastening technique.

For stabilization against premature polymerization, resin mixtures and reactive resin mortars usually contain stabilizers such as hydroquinone, substituted hydroquinones, phenothiazine, benzoquinone or tert-butylpyrocatechol, as described in EP 1935860 A1 or EP 0965619 A1, for example. These stabilizers impart a storage stability of several months to the reactive resin mortar although this is usually applicable only in the presence of oxygen dissolved in the reactive resin mortar. If stored in the absence of air, polymerization begins after only a few days. For this reason, it has been necessary in the past it to package these reactive resin mortars in such a way that they come in contact with air.

DE 19531649 A1, for example, describes the stabilization of reactive resin mortars based on radically curable compounds to prevent premature polymerization in the absence of air using stable nitroxyl radicals, also known as N-oxyl radicals, namely piperidinyl-N-oxyl and tetrahydropyrrole-N-oxyl. Therefore, 4-hydroxy-2,2,6,6-tetramethylpiperidine-N-oxyl (also known as tempol) is often used now for stabilization when a reactive resin mortar is stored in the absence of air. Tempol has the advantage that the gel time can also be adjusted in this way.

However, the inventors have observed that the storage stability of resin mixtures and reactive resin mortars stabilized with tempol containing acids or traces of acids is reduced in comparison with those containing little or no acids or traces of acids. Furthermore, a gel time drift has been observed in some cases with reactive resin mortars that contain acids or traces of acids and whose gel time has been adjusted to a certain level with tempol. Larger amounts of acid in particular can have a negative effect on the storage stability and the gel time stability.

The object of the present invention is to stabilize resin mixtures based on radically curable compounds and the reactive resin mortars produced from them to prevent premature polymerization.

This object is achieved by using a combination of a stable nitroxyl radical and a quinone methide having the features of claim 1 and by the method having the features of claim 11.

Another object of the invention is to provide resin mixtures and the reactive resin mortars containing same that are stable in storage and have an improved storage stability, in particular in airtight packages, even in the presence of traces of acid.

This additional object is achieved by a resin mixture having the features of claim 14 and by a reactive resin mortar containing the same and having the features of claim 24.

Meanings used in the sense of the invention:

“Basic resin”: The pure curing and/or curable compound which cures by itself or with reactive reagents such as curing agents, accelerators and the like (not present in the basic resin), by polymerization; the curable compounds may be monomers, dimers, oligomers and prepolymers;

“Radically curable compound”: The compound contains functional groups that undergo free radical polymerization;

“Resin masterbatch”: The product of production of the basic resin after synthesis (without isolating the basic resin), which may contain reactive diluents, stabilizers and catalysts;

“Resin mixture”: A mixture of the resin masterbatch and accelerators plus stabilizers and optionally additional reactive diluents; this term is used as equivalent to the term “organic binder”;

“Reactive resin mortar”: A mixture of resin mixture and organic and inorganic additives for which the term “A component” is used as equivalent;

“Reactive resin compound”: A ready-to-process curing mixture of a reactive resin mortar with the required curing agent; this term is used as equivalent to the term “mortar compound”;

“Curing agent”: Substances which cause the polymerization (curing) of the basic resin;

“Hardener”: A mixture of curing agents, optionally stabilizers, solvent(s) and optionally organic and/or inorganic additives; this term is used as equivalent to the term “B component”;

“Reactive diluent”: Liquid or low viscosity basic resins which dilute other basic resins, the resin masterbatch or the resin mixture and thereby impart the required viscosity to their application, containing functional groups capable of reaction with the basic resin and becoming a predominant part of the cured compound (mortar) in the polymerization (curing);

“Accelerator”: A compound capable of accelerating the polymerization reaction (curing), which serves to accelerate the formation of the radical initiator;

“Stabilizer”: A compound capable of inhibiting the polymerization reaction (curing), which serves to prevent the polymerization reaction and thus prevent unwanted premature polymerization of the radically polymerizable compound during storage; these compounds are usually used in such small amounts that the gel time is not affected;

“Inhibitor”: Again, a compound capable of inhibiting, i.e., retarding the polymerization reaction (curing), serving to delay the polymerization reaction immediately after addition of the curing agent; these compounds are usually used in such amounts that do not affect the gel time;

“Storage stability” and/or “stable in storage”: Meaning that a resin mixture or a reactive resin mortar (without the addition of a curing agent or a hardener) does not undergo either gelation or an increase in viscosity during storage;

“Gel time” (also “pot life”): In general, the maximum period of time within which a system consisting of multiple components should be processed after mixing; more precisely, this corresponds to the period of time within which the temperature of the reactive resin compound increases from +25° C. to +35° C. after being prepared;

“Gel time drift” (for a certain period of time, for example, 30 or 60 days): This refers to the phenomenon, whereby the observed gel time differs from the point in time of the reference when curing occurs at a different point in time than the reference standard point in time of curing, for example, 24 hours after preparation of the reactive resin and/or the reactive resin compound.

The inventors have found that it is possible to prepare resin mixtures and the reactive resin mortars prepared from them, in particular those with traces of acid and/or inorganic additives, with an increased storage stability without requiring complex and expensive purification of the components such as precursor compounds, for example, polymeric methylene diphenyl diisocyanate (pMDI) or the reactive diluent.

Reactive resin mortars are usually prepared by placing the starting compounds required to produce the basic resin in a reactor, optionally together with catalysts and solvents, in particular reactive diluents, and reacting them. After the end of the reaction and optionally already at the start of the reaction, inhibitors for storage stability, also called stabilizers, are added to the reaction mixture, thus yielding the so-called resin masterbatch. Accelerators for curing the basic resin, and optionally additional inhibitors, which may be the same as or different from the inhibitor for storage stability, are added to the resin masterbatch to adjust the gel time, and optionally additional solvents, in particular reactive diluents, are added to obtain the resin mixture. This resin mixture is combined with inorganic additives to adjust various properties, such as the rheology and the concentration of the basic resin, thus forming the reactive resin mortar, the A component. For storage, the reactive resin mortar is packaged in glass capsules, cartridges or film bags, which are optionally airtight, depending on the intended application.

Thus, a resin mixture preferably contains at least one radically curable compound, reactive diluent, accelerator, stabilizers and optionally additional inhibitors; and a reactive resin mortar, in addition to containing the resin mixture already described, also contains organic and/or inorganic additives, but inorganic additives are especially preferred, such as those described in greater detail below.

The inventors have found that the storage stability of reactive resin mortars, in particular those that contain traces of acid due to the production process, can be significantly improved. The inventors have shown that this is possible through the use of a combination of (i) at least one stable nitroxyl radical and (ii) at least one quinone methide as the stabilizer, and therefore resin mixtures and reactive resin mortars based on radically curable compounds can be produced, their storage stability being definitely improved in comparison with those stabilized with tempol or a quinone methide alone. It was completely surprising and unexpected that reactive resin mortars stabilized according to the invention have a storage stability that is greater by a factor of five to six than that of the corresponding resin mixtures.

It is advantageous in particular that, contrary to expectations, it has been shown that with the particular combination used, the gel times of the resin mixtures and reactive resin mortars that have been made stable in storage by using the stabilizers according to the invention are not affected, despite their great storage stability.

The use of quinone methides as well as a combination of stable nitroxyl radicals and quinone methides as the stabilizer for unsaturated and/or vinyl aromatic monomers such as styrene is already known from EP 0 737 659 A1, WO 00/36052 A1, WO 02/33026 A1, WO 06/111494 A1 and DE 10 2007 052 891 A1, but with these prior art documents, the unsaturated and/or vinyl aromatic monomers are not complex systems containing, firstly, a larger molecule as radically curable compounds and, secondly, being filled with inorganic additives that give a basic reaction.

In the case of systems filled with inorganic fillers such as those used as dowel compositions for chemical fastening of anchoring elements, inorganic additives, for example, cement, which give a strongly basic reaction are often used. Furthermore, the radically curable compounds are not processed, i.e., isolated, but instead the resin masterbatch is used to prepare the resin mixtures and the reactive resin mortar.

Those skilled in the art are aware of the fact that the additives contained in the resin masterbatch as well as the additional additives and fillers added to the resin masterbatch can have a substantial influence on the stability of the basic resin, i.e., its tendency to premature polymerization without the addition of curing agents during storage. The additives and fillers as well as their concentrations may produce a different and unpredictable effect. Therefore, the systems must be reevaluated and their properties must be adjusted when one component is replaced by another, even if a similar reactivity is to be expected.

Against the background of the results obtained in determination of the stability of a resin mixture and of a corresponding reactive resin mortar, each having been stabilized with tempol or a quinone methide alone, where the differences in stabilities, expressed in time until gelation, are in the range of measurement tolerance, only a moderate increase in stability was to be expected for a resin mixture and/or a reactive resin mortar stabilized with a combination of a stable nitroxyl radical and a quinone methide as the stabilizer.

It was therefore even more surprising that replacing a small amount of a stable nitroxyl radical with a quinone methide could multiply the storage stability of the resin mixture containing inorganic fillers many times over.

Quinone methide compounds that are suitable according to the invention are selected from compounds of the general formula (I)

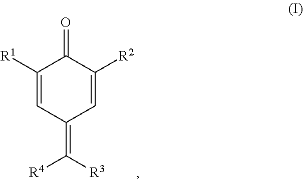

wherein R¹ and R², independently of one another, denote a C₁-C₁₈ alkyl, C₅-C₁₂ cycloalkyl, C₇-C₁₅ phenylalkyl or an optionally substituted C₆-C₁₀ aryl moiety; R³ and R⁴, independently of one another, denote a C₆-C₁₀ aryl, 2-, 3- or 4-pyridyl, 2- or 3-furyl, 2- or 3-thienyl, 2- or 3-pyrryl moiety, optionally substituted with a C₁-C₈ alkyl group, —COOH, —COOR¹⁰, —CONH₂, —CONR¹⁰₂, —CN, —COR¹⁰, —OCOR¹⁰, —OPO(OR¹⁰)₂ or one of R³ or R⁴ denotes hydrogen; R¹⁰ denotes a C₁-C₈ alkyl or phenyl moiety.

R¹ and R², independently of one another, denote a C₁-C₁₈ alkyl moiety, R³ denotes a C₆-C₁₀ aryl, 2-, 3- or 4-pyridyl, 2- or 3-furyl, 2- or 3-thienyl, 2- or 3-pyrryl moiety, optionally substituted with a C₁-C₈ alkyl group, and R⁴ denotes hydrogen.

R¹ and R² especially preferably denote a butyl moiety, in particular tert-butyl moiety, R⁴ denotes hydrogen, and R³ denotes an unsubstituted C₆-C₁₀ aryl moiety, in particular a phenyl moiety.

Such quinone methides as well as their synthesis are known. In this context, reference is made to EP 0744392 A1, the contents of which are herewith incorporated into the present patent application.

Suitable stable nitroxyl radicals are selected from compounds of the general formula (II)

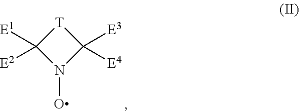

where E¹ and E³, independently of one another, denote a C₁-C₅ alkyl or phenyl moiety, E² and E⁴, independently of one another, denote a C₁-C₅ alkyl moiety, T is a divalent group, which, together with the nitrogen atom and the two quaternary carbon atoms, forms a five- or six-membered ring, where the group T may optionally be substituted and the dot is an unpaired electron. Of these, piperidinyl-N-oxyl or tetrahydropyrrole-N-oxyl compounds are preferred. Such compounds are known from DE 19531649 A1, for example, the contents of which are herewith included in the present patent application.

A combination of (i) 4-hydroxy-2,2,6,6-tetramethylpiperidine-1-oxyl and (ii) 2,6-di-tert-butyl-4-benzylidenecyclohexa-2,5-dien-1-one is especially preferred as a stabilizer.

It has surprisingly been found that the stability of radically curable reactive resins can be increased significantly with a combination in which the at least one stable nitroxyl radical and the at least one quinone methide are present in a molar ratio between 10:1 and 1:9, preferably between 10:1 and 1:3, more preferably 5:1 to 1:1 and most preferably approx. 2:1, in particular in the presence of protic acids, such as a few vinyl ester urethane resins. A maximum increase in stability is achieved at a mixing ratio of 1:9, so that no further effect is achieved by adding a quinone methide to a stable nitroxyl radical at 1:>9. Although the stability remains at a very high level over a wide range, no significant increase was observed—within the observed period of time. At a mixing ratio of >10:1, no positive effect of the quinone methide on the stability is expected, so the stabilizing effect corresponds approximately to that of the pure nitroxyl radical.

Therefore, another subject matter of the present invention is a resin mixture produced using the combination of a stable nitroxyl radical and quinone methide as a stabilizer as described above.

Such a resin mixture has an increased storage stability in comparison with a resin mixture containing a stable nitroxyl radical or a quinone methide as the only stabilizer.

The stabilizer, i.e., the combination of stable nitroxyl radical and quinone methide, is used in an amount of 0.02 to 1 wt %, preferably 0.025 to 0.3 wt % and especially preferably 0.03 to 0.06 wt %, based on the resin mixture.

In one embodiment, the resin mixture may additionally contain 0.005 to 3 wt %, preferably 0.05 to 1 wt %, based on the resin mixture, of another inhibitor, in particular a phenolic inhibitor, such as phenols, quinones or phenothiazines, e.g., 2,6-di-tert-butyl-p-cresol, but also stable nitroxyl radicals such as tempol and catechols, such as pyrocatechol and derivatives thereof, to adjust the gel time and reactivity (cf. EP 1 935 860 A1).

According to the invention, ethylenically unsaturated compounds, cyclic monomers, compounds with carbon-carbon triple bonds and thiol-yn/en resins, such as those with which those skilled in the art are familiar, are suitable radically curable compounds.

Of these compounds, the group of ethylenically unsaturated compounds is preferred, comprising styrene and derivative thereof, (meth)acrylates, vinyl esters, unsaturated polyesters, vinyl ethers, allyl ethers, itaconates, dicyclopentadiene compounds and unsaturated fats, of which unsaturated polyester resins and vinyl ester resins are suitable in particular and are described in the patent applications EP 1 935 860 A1, DE 195 31 649 A1, WO 02/051903 A1 and WO 10/108,939 A1, for example. Vinyl ester resins are the most preferred because of their hydrolytic stability and excellent mechanical properties.

Examples of suitable unsaturated polyesters that may be used according to the invention are divided into the following categories as classified by M. Malik et al. in J. M. S. Rev. Macromol. Chem. Phys., C40 (2 and 3), pp. 139-165 (2000):

(1) Ortho resins: These are based on phthalic anhydride, maleic anhydride or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol A;

(2) Iso resins: These are produced from isophthalic acid, maleic anhydride or fumaric acid and glycols; these resins may contain larger amounts of reactive diluents than the ortho resins;

(3) Bisphenol A fumarates: These are based on ethoxylated bisphenol A and fumaric acid;

(4) HET acid resins (hexachloro-endo-methylene tetrahydrophthalic acid resins): These are resins produced from anhydrides or phenols that contain chlorine/bromine in the synthesis of unsaturated polyester resins.

In addition to these classes of resins, the so-called dicyclopentadiene resins (DCPD resins) may also be differentiated as unsaturated polyester resins. The class of DCPD resins is obtained either by modification of one of the types of resins listed above by Diels-Alder reaction with cyclopentadiene, or, as an alternative, they may be obtained by an initial reaction of a dicarboxylic acid, e.g., maleic acid with dicyclopentadienyl, and then by a second reaction, the standard method of synthesis of an unsaturated polyester resin, where the latter is called a DCPD maleate resin.

The unsaturated polyester resin preferably has a molecular weight Mn in the range of 500 to 10,000 Dalton, more preferably in the range of 500 to 5000 and even more preferably in the range of 750 to 4000 (according to ISO 13885-1). The unsaturated polyester resin has an acid value in the range of 0 to 80 mg KOH/g resin, preferably in the range of 5 to 70 mg KOH/g resin (according to ISO 2114-2000). If a DCPD resin is used as an unsaturated polyester resin, the acid value preferably amounts to 0 to 50 mg KOH/g resin.

In the sense of the present invention, vinyl ester resins are monomers, oligomers, prepolymers or polymers having at least one terminal (meth)acrylate group, so-called (meth)acrylate functionalized resins, which also include urethane (meth)acrylate resins and epoxy (meth)acrylates.

Vinyl ester resins having unsaturated groups only in terminal position, are obtained, for example, by reacting epoxy oligomers or polymers (e.g., bisphenol A digylcidyl ether, epoxies of the phenol-novolac type or epoxide oligomers based on tetrabromobisphenol A) with (meth)acrylic acid or (meth)acrylamide, for example. Preferred vinyl ester resins include (meth)acrylate-functionalized resins and resins obtained by reacting an epoxide oligomer or polymer with methacrylic acid or methacrylamide, preferably methacrylic acid. Examples of such compounds are known from the patent applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

Particularly suitable and preferred vinyl ester resins include (meth)acrylate-functionalized resins obtained by reaction of difunctional and/or higher functional isocyanates with suitable acryl compound, for example, optionally with the participation of hydroxy compounds containing at least two hydroxyl groups, such as those described in DE 3940309 A1, for example.

Isocyanates that can be used include aliphatic (cyclic or linear) and/or aromatic difunctional or higher functional isocyanates and/or the prepolymers thereof. Using such compounds serves to increase the wetting ability and thus to improve adhesion properties. Aromatic difunctional or higher functional isocyanates and/or prepolymers thereof are preferred, and aromatic difunctional or higher functional prepolymers are especially preferred. For example, toluoylene diisocyanate (TDI), diphenylmethane diisocyanate (MDI) and polymeric diphenylmethane diisocyanate (pMDI) may be mentioned for increasing the chain stiffening, and hexane diisocyanate (HDI) and isophorone diisocyanate (IPDI), which improve flexibility, can also be mentioned, but polymeric diphenylmethane diisocyanate (pMDI) is most especially preferred.

Suitable acyl compounds include acrylic acid and substituted acrylic acids, with substituents on the hydrocarbon moiety, such as methacrylic acid, hydroxyl group-containing esters of (meth)acrylic acid with polyvalent alcohols, pentaerythritol tri(meth)acrylate, glycerol di(meth)acrylate, such as, for example, trimethylolpropane di(meth)acrylate, neopentyl glycol mono(meth)acrylate. Preferred examples include (meth)acrylic acid hydroxyalkyl esters, such as hydroxyethyl (meth)acrylate, hydroxypropyl (meth)acrylate, polyoxyethylene (meth)acrylate and polyoxypropylene (meth)acrylate, especially since such compounds serve to provide steric hindrance for the saponification reaction.

Suitable hydroxy compounds that may optionally be used include divalent or higher valent alcohols, such as the derivatives of ethylene oxide and/or propylene oxide, such as ethanediol, diethylene glycol and/or triethylene glycol, propanediol, dipropylene glycol, other diols such as 1,4-butanediol, 1,6-hexanediol, neopentyl glycol, diethanolamine, also bisphenol A and/or F and/or their ethoxylation/propoxylation products and/or hydrogenation and/or halogenation products, higher valent alcohols, such as glycerol, trimethylol propane, hexanetriol and pentaerythritol, polyethers containing hydroxyl groups, for example, oligomers of aliphatic or aromatic oxiranes and/or higher cyclic ethers, such as ethylene oxide, propylene oxide, styrene oxide and furan, polyethers containing aromatic structural units in the main chain, such as, for example, bisphenol A and/or F, polyesters based on the aforementioned alcohols and/or polyethers containing hydroxyl groups and dicarboxylic acids and/or their anhydrides, such as adipic acid, phthalic acid, tetra- and/or hexahydrophthalic acid, HET acid, maleic acid, fumaric acid, itaconic acid, sebacic acid and the like. Hydroxy compounds with aromatic structural units are especially preferred for chain stiffening of the resin, hydroxy compounds containing unsaturated structural units such as fumaric acid to increase the crosslinking density, branched and/or stellate hydroxy compounds, in particular trivalent and/or higher valent alcohols and/or polyethers and/or polyesters containing their structural units, branched and stellate urethane (meth)acrylates to achieve a lower viscosity of the resins and/or solutions thereof in reactive diluents and with a higher reactivity and crosslinking density.

The vinyl ester resin preferably has a molecular weight Mn in the range of 500 to 3000 Dalton, more preferably 500 to 1500 Dalton (according to ISO 13885-1). The vinyl ester resin has an acid value in the range of 0 to 50 mg KOH/g resin, preferably in the range of 0 to 30 mg KOH/g resin (according to ISO 2114-2000).

All these resins that can be used according to the invention may be modified by methods with which those skilled in the art are familiar in order to achieve, for example, lower acid numbers, hydroxide numbers or anhydride numbers or they can be made more flexible by introducing flexible units into the basic structure and the like.

In addition, the resin may also contain other reactive groups that can be polymerized with a radical initiator such as peroxides, for example, reactive groups, which are derived from itaconic acid, citraconic acid and allylic groups and the like.

The use of the combination of a stable nitroxyl radical and a quinone methide in a resin mixture, the curable component of which contains traces of acid, such as mineral acid or carboxylic acid, is especially suitable, such as those formed in the synthesis of the radically curable compound or a precursor compound thereof, for example.

The basic resins are used in an amount of 20 to 100 wt %, preferably 40 to 65 wt %, based on the resin mixture.

In a preferred embodiment of the invention, the resin mixture contains at least one reactive diluent for the curable ingredient (a), wherein the reactive diluent may be added in an amount of 0 to 80 wt %, preferably 30 to 60 wt %, based on the resin mixture. Suitable reactive diluents are described in EP 1 935 860 A1 and DE 195 31 649 A1.

Essentially other conventional reactive diluents may also be used, either alone or in mixture with (meth)acrylic acid esters, for example, styrene, α-methylstyrene, alkylated styrenes, such as tert-butylstyrene, divinylbenzene and allyl compounds.

According to another preferred embodiment of the invention, the resin mixture is present in a pre-accelerated form; in other words, it contains at least one accelerator for the curing agent. Preferred accelerators for the curing agent include aromatic amines and/or salts of cobalt, manganese, tin, vanadium or cerium. Accelerators that have proven to be especially advantageous include N,N-dimethylaniline, N,N-diethylaniline, N,N-diisopropanol-p-toluidine, N,N-diisopropylidene-p-toluidine, N,N-dimethyl-p-toluidine, N,N-diethylol-p-toluidine, N,N-diethylol-m-toluidine, N,N-diisopropylol-m-toluidine, N,N-bis(2-hydroxyethyl)toluidine, N,N-bis(2-hydroxyethyl)xylidine, N-methyl-N-hydroxyethyl-p-toluidine, cobalt octoate, cobalt naphthenate, vanadium(IV) acetylacetonate and vanadium(V)-acetylacetonate.

According to the invention, the accelerator and/or the accelerator mixture is/are added in an amount of 0.05 to 5 wt %, preferably 1.3 to 3 wt %, based on the resin mixture.

The resin mixtures according to the invention may be used to prepare reactive resin mortars for the chemical fastening technology. The reactive resin mortars prepared according to the invention are characterized by a particularly good storage stability—even in the absence of atmospheric oxygen.

Another subject matter of the invention is therefore a reactive resin mortar, which contains, in addition to the resin mixture, the usual inorganic additives such as fillers, thickeners, thixotropy agents, nonreactive solvents, agents to improve flow properties and/or wetting agents. The fillers preferably consist of particles of quartz, quartz sand, corundum, calcium carbonate, calcium sulfate, glass and/or organic polymers of a wide range of sizes and shapes, for example, as sand or powder, in the form of solid beads or hollow beads, but also in the form of fibers of organic polymers such as, for example, polymethyl methacrylate, polyester, polyamide or in the form of microbeads of polymers (bead polymers). Inert globular substances (spherical shape) are preferred and have a definite strengthening effect.

Suitable thickeners or thixotropy agents include those based on silicates, bentonite, laponite, pyrogenic silica, polyacrylates and/or polyurethanes.

Another subject matter of the invention is a multicomponent mortar system, comprising at least two (spatially) separate components A and B. The multicomponent mortar system comprises two or more separate, interconnected and/or interleaved containers, wherein the one includes component A, the reactive resin mortar, and the other includes component B, the hardener which may optionally be filled with organic and/or inorganic additives.

The multicomponent mortar system may be present in the form of a capsule, a cartridge or a film bag. When the reactive resin mortars according to the invention are used as intended, component A and component B are combined by expressing them from the capsules, cartridges or film bags, either under the influence of mechanical forces or by gas pressure, preferably with the help of a static mixer, through which the ingredients are passed and introduced into the borehole, after which the facilities to be solidified such as threaded anchor rods or the like are introduced into the borehole that has been charged with the curing reactive resin and then adjusted accordingly.

Preferred hardeners are organic peroxides that are stable in storage. Dibenzoyl peroxide and methyl ethyl ketone peroxide as well as tert-butyl perbenzoate, cyclohexanone peroxide, lauryl peroxide and cumene hydroperoxide as well as tert-butylperoxy-2-ethylhexanoate are especially suitable.

The peroxides are used in amounts of 0.3 to 15 wt %, preferably 1 to 5 wt %, based on the reactive resin mortar.

The hardeners are expediently stabilized by inert fillers, where quartz sand is preferred.

In a particularly preferred embodiment of the multicomponent mortar system according to the invention, the A component also contains, in addition to the curable compounds, (a) a hydraulically setting or polycondensable inorganic compound, in particular cement, and the B component also contains water in addition to the curing agent. Such hybrid mortar systems are described in detail in DE 42 31 161 A1, where the A component preferably contains cement, for example, Portland cement or aluminate cement as the hydraulically setting or polycondensable inorganic compound, wherein cements having little or no iron oxide content are particularly preferred. Gypsum as such or in mixture with cement may also be used as the hydraulically setting inorganic compound.

The A component may also comprise as the polycondensable inorganic compound, silicatic, polycondensable compounds, in particular substances containing soluble, dissolved and/or amorphous silicon dioxide.

The great advantage of the invention is that it is no longer necessary to test the components of the resin composition such as the curable compound or its precursors for traces of acid, such as mineral acid, or to subject them to an expensive and complex purification process, although this may be necessary in some cases. There is a significant increase in the stability of reactive resin mortars during storage in particular.

The following examples are presented to further illustrate the present invention.

### EXEMPLARY EMBODIMENTS

### Comparative Examples V1 and V2 Plus Examples 1 to 4

### 1) Production of the Resin Masterbatch

688 g hydroxypropyl methacrylate was mixed with 0.5 mL dibutyltin dilaurate and 0.4 g 4-hydroxy-2,2,6,6-tetramethylpiperidine-1-oxyl. Then at 60° C., 311 g polymeric methylene diphenyl diisocyanate (pMDI; Desmodur VL R 20®, maximum acidity value: 200 ppm HCl; Bayer) was added slowly by drops, whereupon the internal temperature rose to 85° C. After the end of the dropwise addition, stirring was continued until the residual isocyanate content had dropped to less than 0.2%.

### 2) Production of the Resin Mixture

The amounts shown in Table 1 for Irgastab® UV22 (2,6-bis(1,1-dimethylethyl)-4-(phenylenemethylene)cyclohexa-2,5-dien-1-one; 16 wt % solution in glyceryl propoxy triacrylate; BASF) were added to the resulting resin masterbatch. Furthermore, 698 g 1,4-butanediol dimethacrylate was added as a reactive diluent. The gel time of the resin was set at approx. 7 min using one or more aromatic amines.

For comparison (Comparative Example 1; V1) an additional 0.6 g of 4-hydroxy-2,2,6,6-tetramethylpiperidine-1-oxyl was added instead of the Irgastab® UV22. As a further comparison (Comparative Example 2; V2) 4.43 g Irgastab® UV22 (2,6-bis(1,1-dimethylethyl)-4-(phenylenemethylene)cyclohexa-2,5-dien-1-one; 16 wt % solution in glyceryl propoxy triacrylate; BASF) was added instead of the 4-hydroxy-2,2,6,6-tetramethylpiperidine-1-oxyl.

TABLE 1
Amounts of tempol and Irgastab ® UV22 used.

| Example | V1 | V2 | 1 | 2 | 3 | 4 | 5 | 6 | 7 | 8 | 9 |
|---|---|---|---|---|---|---|---|---|---|---|---|
| Tempol¹ (g) | 1.0 | 0 | 0.4 | 0.4 | 0.4 | 0.4 | 0.4 | 0.4 | 0.4 | 0.4 | 0.4 |
| Irgastab ® UV22 (g) | — | 4.43 | 55.4 | 33.3 | 18.5 | 11.1 | 3.8 | 2.5 | 2.3 | 1.3 | 0.4 |
| Molar ratio | ∞³ | 0 | 0.07 | 0.11 | 0.2 | 0.33 | 1 | 1.4 | 1.7 | 3.3 | 10 |
| tempol: QM² | | | | | | | | | | | |

¹4-Hydroxy-2,2,6,6-tetramethylpiperidine-1-oxyl
²QM = quinone methide, 2,6-bis(1,1-dimethylethyl)-4-(phenylenemethylene)cyclohexa-2,5-dien-1-one
³A ratio of ∞ means that tempol is used as a stabilizer without any QM

Determination of the Gel Time of the Resin Mixtures

To simulate a longer storage time, the samples were subjected to a thermostability test at an elevated temperature. The resin sample (resin mixture) in 20 mL portions was welded in an oxygen-tight film (11×17 cm) and thermostatically regulated at 80° C. The sample was observed to determine whether gelation occurs during storage. The resulting tangible increase in viscosity (consistency on gelation: like liquid honey to like gummy bears (gelatinous)) provides information about thermostability. As comparison the resin mixtures prepared in Comparative Examples 1 and 2 were used, with the resin mixture stabilized in the case of tempol (Comparative Example 1) remaining stable for at least 31 hours but undergoing gelation after 47 hours at the latest, and the resin mixture stabilized with 2,6-bis(1,1-dimethylethyl)-4-(phenylenemethylene)cyclohexa-2,5-dien-1-one remaining stable for at least 127 hours.

Two double determinations were performed independently of each other. The maximum time at which the sample had not yet gelled was obtained as the result. Table 2 lists the results.

TABLE 2
Gel times of the resin mixtures.

| Example | V1 | V2 | 1 | 2 | 3 | 4 | 5 | 6 | 7 | 8 | 9 |
|---|---|---|---|---|---|---|---|---|---|---|---|
| Time until | 31 | 127 | 300 | 300 | 268 | 164 | 84 | 71 | 98 | 60 | 45 |
| gelation (h) | | | | | | | | | | | |

It is apparent from Table 2 that by using a combination of 4-hydroxy-2,2,6,6-tetramethylpiperidine-1-oxyl with 2,6-bis(1,1-dimethylethyl)-4-(phenylenemethylene)cyclohexa-2,5-dien-1-one as the stabilizer, the gel times of the resin mixtures could be increased in comparison with exclusive use of 4-hydroxy-2,2,6,6-tetramethylpiperidine-1-oxyl and/or 2,6-bis(1,1-dimethylethyl)-4-(phenylenemethylene)cyclohexa-2,5-dien-1-one.

### 3) Production of the Reactive Resin Mortar

The resin mixtures prepared as described above were mixed with 30 to 45 wt % quartz sand, 15 to 25 wt % cement and 1 to 5 wt % pyrogenic silica in the dissolver to form a homogenous mortar composition, i.e., the reactive resin mortars.

Determination of the Gel Time of the Reactive Resin Mortar

The gel time of the reactive resin mortars was determined as done in the case of the resin mixtures. Table 3 lists the results.

TABLE 3
Gel times of the reactive resin mortars.

| Ex- | | | | | | | | | | | |
|---|---|---|---|---|---|---|---|---|---|---|---|
| ample | V1 | V2 | 1 | 2 | 3 | 4 | 5 | 6 | 7 | 8 | 9 |
| Time | 31 | 140 | >300 | >300 | >300 | >300 | 267 | 235 | >300 | >300 | 116 |
| until | | | | | | | | | | | |
| gel- | | | | | | | | | | | |
| ation | | | | | | | | | | | |
| (h) | | | | | | | | | | | |

Table 3 shows that by using a combination of 4-hydroxy-2,2,6,6-tetramethylpiperidine-1-oxyl with 2,6-bis(1,1-dimethylethyl)-4-(phenylenemethylene)cyclohexa-2,5-dien-1-one as the stabilizer, the gel times of the reactive resin mortars can be increased several times, i.e., by a factor of up to about 10 in comparison with sole use of 4-hydroxy-2,2,6,6-tetramethylpiperidine-1-oxyl and/or 2,6-bis(1,1-dimethylethyl)-4-(phenylenemethylene)cyclohexa-2,5-dien-1-one.

The results listed in Tables 1 to 3 show clearly that even with the addition of a very small amount of 2,6-bis(1,1-dimethylethyl)-4-(phenylenemethylene)cyclohexa-2,5-dien-1-one to tempol, a slight increase in the stability of the resin mixture is achieved, but there is an unexpectedly strong increase in the stability of the resin mixture containing the inorganic filler, the reactive resin mortar. The stability of the resin mixture and also that of the reactive resin mortar increases, wherein the increase in the case of the resin mixture as well as that of the reactive resin mortar increases, but the increase in the case of the resin mixture is less pronounced than that with the reactive resin mixture, which is already higher by a factor of 5.5 with a molar ratio of tempol to 2,6-bis(1,1-dimethylethyl)-4-(phenylenemethylene)cyclohexa-2,5-dien-1-one of approx. 3:1 higher than that of the resin mixture on which the reactive resin mortar is based. Beyond a molar ratio of tempol to 2,6-bis(1,1-dimethylethyl)-4-(phenylenemethylene)cyclohexa-2,5-dien-1-one of greater than 1:9, a difference between a filled resin mixture and a resin mixture containing inorganic filler can no longer be observed.

It has thus been demonstrated that it has been possible to significantly increase the stability of resin mixtures containing inorganic fillers in storage on the basis of reactive resins containing traces of oxygen and thereby prolong the storage life significantly.

1. A method of stabilizing a resin mixture or a reactive resin mortar based on at least one radically curable compound or its precursor mixture comprising using a combination of (i) at least one stable nitroxyl radical and (ii) at least one quinone methide.

2. The method according to claim 1, wherein the at least one quinone methide is selected from compounds of general formula (I) 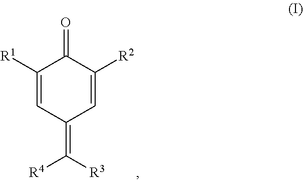
in which R¹ and R², independently of one another, denote a C₁-C₁₈ alkyl, a C₅-C₁₂ cycloalkyl, a C₇-C₁₅ phenylalkyl or an optionally substituted C₆-C₁₀ aryl moiety;
R³ and R⁴, independently of one another, denote a C₆-C₁₀ aryl, 2-, 3- or 4-pyridyl, 2- or 3-furyl, 2- or 3-thienyl, 2- or 3-pyrryl moiety, optionally substituted with a C₁-C₈ alkyl group, —COOH, —COOR¹⁰, —CONH₂, —CONR¹⁰₂, —CN, —COR¹⁰, —OCOR¹⁰, —OPO(OR¹⁰₂ or one of R³ or R⁴ is hydrogen; R¹⁰ is a C₁-C₈ alkyl or phenyl moiety.

3. The method according to claim 2, wherein in formula (I) R¹ and R² independently of one another denote a C₁-C₁₈ alkyl moiety, R³ is a C₆-C₁₀ aryl, 2-, 3- or 4-pyridyl, 2- or 3-furyl, 2- or 3-thienyl, 2- or 3-pyrryl moiety, optionally substituted with a C₁-C₈ alkyl group, and R⁴ denotes hydrogen.

4. The method according to claim 1, wherein the at least one stable nitroxyl radical is selected under conditions of general formula (II) 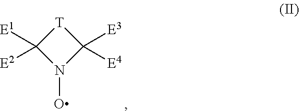
where E¹ and E³, independently of one another, denote a C₁-C₅ alkyl or phenyl moiety,
E² and E⁴, independently of one another, denote a C₁-C₅ alkyl moiety,
T denotes a divalent group which together with the nitrogen atom and the two quaternary carbon atoms, denotes a five- or six-membered ring, where the group T may optionally be substituted,
the dot denotes an unpaired electron.

5. The method according to claim 4, wherein the at least one stable nitroxyl radical is a piperidinyl-N-oxyl or tetrahydropyrrole-N-oxyl.

6. The method according to claim 1, wherein the stabilizer is a combination of (i) 4-hydroxy-2,2,6,6-tetramethylpiperidine-1-oxyl and (ii) 2,6-di-tert-butyl-4-benzylidenecyclohexa-2,5-dien-1-one.

7. The method according to claim 1, wherein the at least one stable nitroxyl radical and the at least one quinone methide are present in a molar ratio between 10:1 and 1:9.

8. The method according to claim 1, wherein the radically curable compound is obtained by reacting difunctional and/or higher functional isocyanates with suitable acryl compounds, optionally with the participation of hydroxy compounds containing at least two hydroxyl groups each.

9. The method according to claim 1, wherein the reactive resin mortars contain at least one inorganic additive selected from the group consisting of fillers, thickeners, thixotropy agents, nonreactive solvents, agents to improve flowability and/or wetting agents.

10. The method according to claim 9, wherein the at least one inorganic additive is cement and/or quartz sand.

11. (canceled)

12. The method according to claim 144, wherein the stabilizer is used in an amount of 0.02 to 1 wt %, based on the resin mixture.

13. The method according to claim 1, wherein the radically polymerizable compound is obtained by reacting difunctional and/or higher functional isocyanates having suitable acryl compounds, optionally with the participation of hydroxy compounds having at least two hydroxyl groups.

14. A resin mixture containing as a curable constituent (a) at least one radically curable compound, at least one reactive diluent, (b) and as the stabilizer (c) a combination of (i) at least one stable nitroxyl radical and (ii) at least one quinone methide.

15. The resin mixture according to claim 14, wherein the at least one quinone methide is selected from compounds of general formula (I) 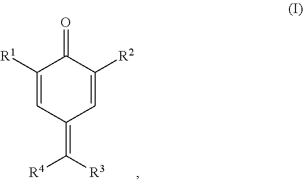
wherein R¹ and R² independently of one another denote a C₁-C₁₈ alkyl, C₅-C₁₂ cycloalkyl, C₇-C₁₅ phenylalkyl or an optionally substituted C₆-C₁₀ aryl moiety;
R³ and R⁴, independently of one another, denote a C₆-C₁₀ aryl, 2-, 3- or 4-pyridyl, 2- or 3-furyl, 2- or 3-thienyl, 2- or 3-pyrryl moiety substituted with a C₁-C₈ alkyl group, —COOH, —COOR¹⁰, —CONH₂, —CONR¹⁰₂, —CN, —COR¹⁰, —OCOR¹⁰, —OPO(OR¹⁰)₂ or one of R³ or R⁴ denotes hydrogen;
R¹⁰ is a C₁-C₈ alkyl or phenyl moiety.

16. The resin mixture according to claim 15, wherein in formula (I) R¹ and R² independently of one another denote a C₁-C₁₈ alkyl moiety, R³ denotes a C₆-C₁₀ aryl, 2-, 3- or 4-pyridyl, 2- or 3-furyl, 2- or 3-thienyl, 2- or 3-pyrryl moiety, optionally substituted with a C₁-C₈ alkyl group, and R⁴ denotes hydrogen.

17. The resin mixture according to claim 11, wherein the at least one stable nitroxyl radical is selected from compounds of general formula (II) 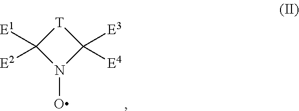
where E¹ and E³ independently of one another denote a C₁-C₅ alkyl or phenyl moiety,
E² and E⁴ independently of one another denote a C₁-C₅ alkyl moiety,
T is a divalent group which, together with the nitrogen atom and the two quaternary carbon atoms form a five- or six-membered ring, wherein the group T may optionally be substituted,
the dot is an unpaired electron.

18. The resin mixture according to claim 17, wherein the at least one stable nitroxyl radical is a piperidinyl-N-oxyl or tetrahydropyrrole-N-oxyl.

19. The resin mixture according to claim 14, wherein the stabilizer is a combination of 4-hydroxy-2,2,6,6-tetramethylpiperidine-1-oxyl and 2,6-di-tert-butyl-4-b enzylidenecyclohexa-2,5-dien-1-one.

20. The resin mixture according to claim 14, wherein the at least one stable nitroxyl radical and the at least one quinone methide are present in a molar ratio between 10:1 and 1:9.

21. The resin mixture according to claim 14, wherein the stabilizer (c) is present in an amount of 0.02 to 1 wt % based on the resin mixture.

22. The resin mixture according to claim 14, wherein the radically polymerizable compound is obtained by reaction of difunctional and/or higher functional isocyanates with suitable acryl compounds, optionally with the participation of hydroxy compounds that contain at least two hydroxyl groups.

23. The resin mixture according to claim 14, which also contains at least one accelerator for curing the radically curable compound.

24. A reactive resin mortar that contains a resin mixture according to claim 14.

25. The reactive resin mortar according to claim 24, that contains at least one inorganic additive, selected from the group consisting of fillers, thickeners, thixotropy agents, nonreactive solvents, agents to improve flowability and/or wetting agents.

26. The reactive resin mortar according to claim 25, wherein the at least one inorganic additive is cement and/or quartz sand.

27. A multicomponent mortar system that contains, as the A component, the reactive resin mortar according to claim 24 and, as the B component, a hardener for the radically curable compound.

28. The multicomponent mortar system according to claim 27, wherein the A component additionally contains a hydraulically setting or polycondensable inorganic compound in addition to the reactive resin mortar, and the B component also contains water in addition to the hardener.

29. A method of chemical fastening comprising using the multicomponent mortar system according to claim 27 as a binder for chemical fastening.

30. A capsule, cartridge or film bag, comprising the multicomponent mortar system according to claim 27, wherein they comprise two or more separate chambers in which the reactive resin mortar and/or hardener is/are situated.
